(19) United States
(12) Patent Application Publication
(10) Pub. No.: US 2005/0124412 A1
(43) Pub. Date: Jun. 9, 2005

(54) Haptic simulation system and method for providing real-time haptic interaction in virtual simulation

(76) Inventors: Wookho Son, Taejon (KR); Ki Hong Kim, Taejon (KR); Hong Kee Kim, Taejon (KR); Hyung Rae Kim, Seoul (KR); Jin Sung Choi, Taejon (KR)

Correspondence Address: JACOBSON, PRICE, HOLMAN & STERN;PROFESSIONAL LIMITED LIABILITY COMPANY, 400 Seventh Street, N.W., Washington, DC, 20004, US

(21) Appl. No.: 10/876,870

(22) Filed: Jun. 28, 2004

(30) Foreign Application Priority Data
Dec. 5, 2003 (KR) 2003-88249

(51) Int. Cl. G06F 19/00

(52) U.S. Cl. 463/30; 463/36

(57) ABSTRACT

Disclosed is a haptic simulation system and method for providing real-time haptic interaction in the haptic simulation system which allows a user (avatar) to feel an effect followed by a collision between the avatar and a surrounding virtual object in the form of a real-time haptic interaction through a haptic simulation device while the user performs a computer simulation. The simulation method includes the steps of: (a) operating an avatar within a virtual environment depending on a motion of the user in a haptic device while performing a haptic simulation; (b) perceiving a collision information of when the avatar of the user collides with an object of the virtual environment; (c) computing force/torque on the collision information on the basis of physical dynamics; (d) when the processing time of the step (c) exceeds a prescribed time, computing force/torque on the collision information using an interpolation method instead of the physical dynamics-based processing; and (e) transferring the force/torque values computed in the steps (c) and (d) to the user haptic device to provide the user with the haptic interaction.

### BACKGROUND OF THE INVENITON

1. Field of the Invention

The present invention relates to a haptic simulation system and method for providing real-time haptic interaction in the haptic simulation system, and more particularly, to a haptic simulation system and method for providing real-time haptic interaction in the haptic simulation system which allows a user (avatar) to feel an effect followed by a collision between the avatar and a surrounding virtual object in the form of a real-time haptic interaction through a haptic simulation device while the user performs a computer simulation.

2. Description of the Related Art

In general, the haptic interface technology is an intuitive anthropocentric interaction technology to complement the prior interaction method depending only on the senses of sight and hearing and thus provide a user with a new dimensional absorbing feeling complements, and has many applications in various fields, such as a virtual discipline of virtual medical treatment/virtual manufacture/virtual combat, etc., a virtual entertainment, a remote fine control and so forth.

However, due to a technical problem in manufacturing a haptic hardware device being a medium for a haptic interface and a deficiency in the implementation technology of a software for effectively driving the haptic hardware device and a software for providing a real-time haptic interaction in a virtual simulation environment, only a haptic interaction technology of a limited feeling is provided until now in worldwide.

Thus, due to the technical difficulty followed by providing the realistic haptic interaction, the haptic interface is applied in reproducing a vibration circumstance suitable for a computer game field in the form of force feedback, is commercialized and is also being used in a remote control through the force feedback in a dangerous environment, but it has a limited application.

In the meanwhile, in order to provide a realistic haptic interaction in a virtual simulation environment using a given haptic hardware device, there is a need of implementing an effective software for creation of the haptic interaction. This implementation depends directly on a method capable of effectively executing on a computer a haptic circulation cycle including sensing of a real-time precise collision, computing force/toque by a precise physical dynamics according to a state of a contact surface (point) and transferring the computed valve to the haptic device, and in real-time graphically displaying of a virtual environment.

However, there is almost nothing in the related arts on researches or technical development dealing with this software interface establishing method for the formation of a realistic haptic interaction.

In the meanwhile, as one of related arts, Korean Patent Publication No. 2002-0066446 entitled ‘Apparatus and method for reproducing midi file’ relates to apparatus and method for reproducing a midi file having a format of storage/reproduction of music. More particularly, the prior art relates to the methodology that receives sound information contained in the midi file, independently converts the sound information to light or vibration corresponding to the height, strength and weakness of the sound and reproduces the sound thereby providing a user with visual and haptic effects as well as hearing effect at the same time. This prior art relates to a haptic reproduction technology in a restrictive meaning, which allows a sense corresponding to haptic interaction to be transferred to a user putting on a sensory vibrator for the purpose of entertainment application, but is strictly speaking different than the method of implementing a fine haptic interaction pursued by the present invention.

Also, U.S. Pat. No. 6,353,850B1 entitled ‘Force feedback provided in web pages’ is a technique related with the methodology that downloads an HTML file from a client, the HTML file being provided therein with creation instruction of force feedback effect provided from a server, and properly reproduces the force feedback effect through a force feedback device connected to the client. The core of this prior art interprets force feedback effect file of a special format and creates a force feedback signal specialized for the hardware structure of the force feedback device. This technique is applied even to force feedback game as well as web application providing contents on the Internet with the haptic interaction, and is used to generate the vibration effect.

In addition, U.S. Pat. No. 6,366,272B1 entitled ‘Providing interactions between simulated objects using force feedback’ deals with methodology transferring a user called avatar in a general simulation environment with a haptic interaction caused by a contact between the avatar and another virtual object through a haptic device in terms of hardware and software technologies, but it does not deal with the methodology of fine haptic interaction creation according to various collision circumstances. In actuality, creating various haptic interactions in a simulation environment is the core of a technology that creates a force feedback suitable for the physical dynamics of collision circumstance after exactly perceiving a collision, and transfers the created force feedback to the haptic device. To this end, the software technology that can effectively implement the aforementioned procedures is essentially requested.

### SUMMARY OF THE INVENTION

Accordingly, the present invention is directed to a haptic simulation system and method for providing real-time haptic interaction in the haptic simulation system that substantially obviates one or more problems due to limitations and disadvantages of the related art.

An object of the present invention is to provide a haptic simulation system and method for providing real-time haptic interaction in the haptic simulation system which allows a user (avatar) to feel an effect followed by a collision between the avatar and a surrounding virtual object in the form of a real-time haptic interaction through a haptic simulation device while the user performs a computer simulation.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a haptic simulation system comprising: a haptic device for providing a user with a realistic haptic interaction; a graphic display module for outputting and displaying an avatar depending on a motion of the user and a virtual environment while performing a simulation; a collision-perceiving module for perceiving a real-time collision information between the avatar and a virtual object in a simulation environment; a physical dynamics-based force/torque-computing module supplied with the collision information to compute force/torque on the basis of physical dynamics and transfer the computed force/torque to the haptic device; and a dispersion-computing module being in charge of dispersion computing and synchronization between the graphic display module, the collision-perceiving module and the physical dynamics-based force/torque-computing module during a haptic circulation cycle.

In another aspect of the present invention, there is provided a method for providing a real-time haptic interaction in a haptic simulation system, the method comprises the steps of: (a) operating an avatar within a virtual environment depending on a motion of the user in a haptic device while performing a haptic simulation; (b) perceiving a collision information of when the avatar of the user collides with an object of the virtual environment; (c) computing force/torque on the collision information on the basis of physical dynamics; (d) when the processing time of the step (c) exceeds a prescribed time, computing force/torque on the collision information using an interpolation method instead of the physical dynamics-based processing; and (e) transferring the force/torque values computed in the steps (c) and (d) to the user haptic device to provide the user with the haptic interaction.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a block diagram of a haptic simulation system according to the present invention; and

FIG. 2 is a flow chart illustrating a real-time haptic providing process of a haptic simulation system according to the present invention.

### DETAILED DESCRIPTION OF THE INVENTION

Reference will now be made in detail to the preferred embodiments of the present invention, examples of which are illustrated in the accompanying drawings.

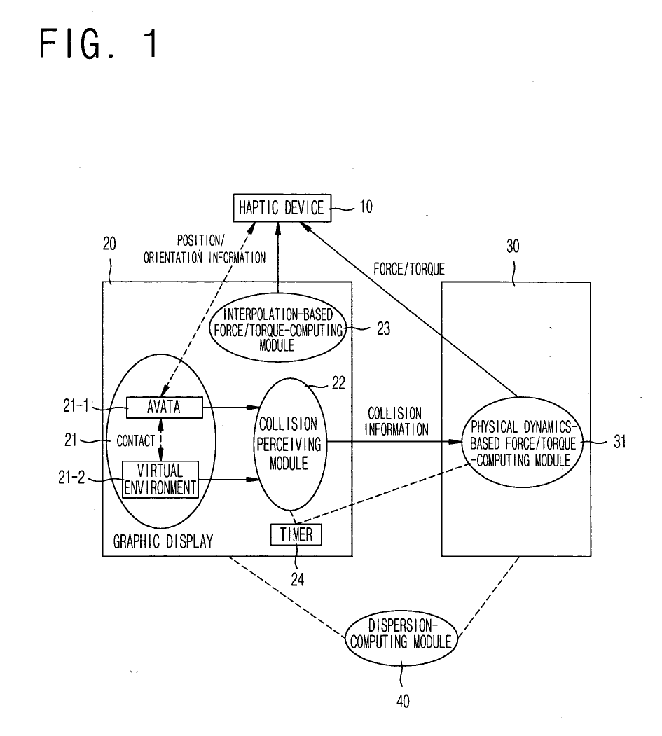

FIG. 1 is a block diagram of a haptic simulation system according to the present invention.

Referring to FIG. 1, a haptic simulation system of the present invention is configured to include a haptic device 10 for directly providing a user with a haptic interaction in the form of force-feedback, a graphic display module 21 for outputting an avatar 21-1 and a virtual environment 21-2, an interpolation-based force/torque computing module 23, a physical dynamics-based force/torque-computing module 31 for computing force/torque on the basis of physical dynamics, a collision-perceiving module 22 being in charge of a real-time collision processing between the avatar and a virtual environment (object), a dispersion-computing module 40 being in charge of synchronization between a computing result of force and torque based on the physical dynamics and a force feedback output, and a timer 24 clocking an execution time of force/torque computation based on the physical dynamics.

The haptic device 10 is a physical medium between a user and an virtual simulation environment and has a function providing a haptic interaction by providing a force corresponding to a collision generated under a circumstance that the avatar collides with or is in contact with other object, in the form of force feedback. Especially, this haptic device 10 is operated by a micro-sized servo motor, has a freedom of six in a three-dimensional space, and can provide a haptic interaction of high resolution on a moving dot contact point.

The avatar 21-1 indicating a user's contact point in a virtual environment on a simulation displayed by a graphic is controllable by the haptic device 10 of a multi-joint body with a high resolution and is movable in the virtual space with the freedom of six. The avatar collides with and is in contact with other object in a virtual environment while moving depending on a user's motion. At this time, the generated impulse is computed in the form of force/torque on the basis of physical dynamics and is transferred in real-time to the haptic device 10 so that the user can feel realistic haptic interaction.

Also, the virtual environment 21-2 indicates other objects other than the avatar 21-1 on a graphic of the simulation, and collides with or is in contact with the avatar 21-1, which moves as the user operates the haptic device 10, during the simulation.

In addition, when the avatar 21-1 collides with or is in contact with an object pertaining to the virtual environment, the collision-perceiving module 22 is in charge of a role grasping the exact collision information and transferring the grasped collision information to the physical dynamics-based force/torque-computing module 31.

The physical dynamics-based force/torque computing module 31 computes the impulse matched with a corresponding collision circumstance in the form of force/torque on the basis of physical dynamics by using the information on the collision and contact transferred from the collision-perceiving module 22, and provides a user with the haptic interaction by transferring the impulse computed differently depending on various collision circumstances to the haptic device 10.

Since this physical dynamics-based force/torque-computing module 31 needs the largest computing time among all procedures of the haptic circulation, it is preferable implemented by a separate CPU or thread.

The interpolation-based force/torque computing module 23 is a module, which is called and executed instead of the corresponding physical dynamics-based force/torque computing module 31 being disregarded when the processing time of the physical dynamics-based force/torque computing module 31 transferred in real time to the user for the formation of the haptic interaction is overtime, and computes a next step of force/torque using interpolation. The interpolation-based force/torque-computing module 23 makes an important role in executing the real-time haptic circulation cycle that is essential for the formation of the realistic haptic interaction.

The timer 24 checks the processing time of a corresponding computing module after the collision-perceiving module 22 transfers the collision information to the physical dynamics-based force/torque computing module 31. At this time, if the checked processing time is overtime, it computes the force/torque using interpolation and transfers the computed result to the haptic device 10.

In the meanwhile, the dispersion computing module 40 of FIG. 1 is a part being in charge of synchronization between a process 20 being in charge of graphic display on the simulation environment including the avatar, and a process 30 being in charge of creating force/torque based on the physical dynamics. The dispersion-computing module 40 is executed by a separate CPU over a network (TCP/IP) or by two different threads on a single CPU.

The core of the inventive haptic simulation system is characterized in that the physical dynamics-based force/torque module 31 requesting the longest execution time in the haptic circulation cycle is distributed. Another one is to provide a user with effective and stable haptic interaction by not depending on the computation of the force/torque based on the physical dynamics but computing the force/torque using the interpolation more simple than the computation of the force/torque based on the physical dynamics if necessary so as to execute the real-time haptic circulation cycle.

The interpolation applied to the present invention is a technique for basically computing the force/torque to be transferred to the haptic device 10 in the next step from the computed values of the force/torque in the previous step and the current step. The interpolation provides a relatively less exact haptic interaction compared with the exact method based on the physical dynamics, but is elected as the second best method under a real-time limitation and permits a fine haptic interaction to be provided.

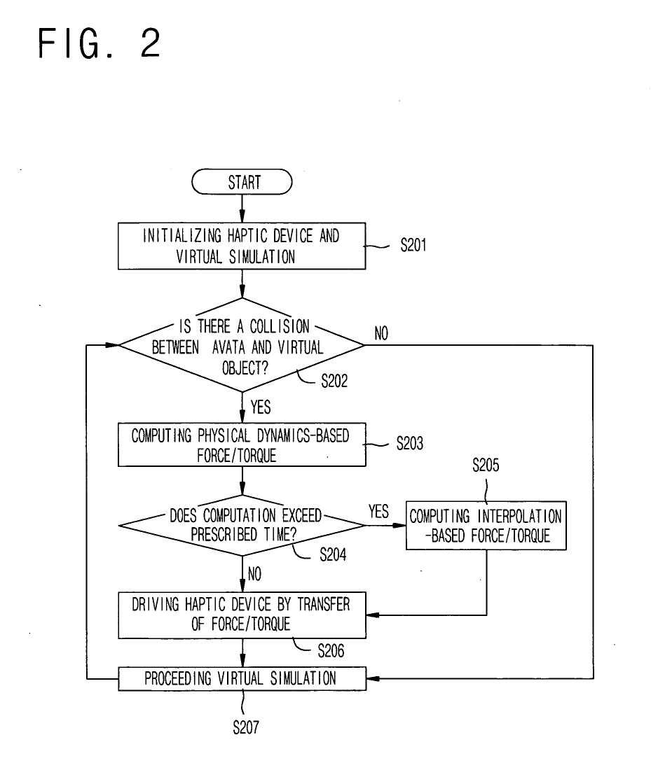

FIG. 2 is a flow chart illustrating a real-time haptic providing process of a haptic simulation system according to the present invention.

Referring to FIG. 2, in the step S201, the inventive haptic system first initializes the haptic device 10 and the graphic display.

If the avatar depending on a user's motion collides with or is in contact with other object (S202) while the haptic simulation is progressed, such a collision or contact degree is perceived and accordingly force/torque based on the physical dynamics is computed (S203).

At this time, if the computation of the force/torque exceeds a time prescribed for the purpose of real-time execution of the haptic circulation cycle (S204), the computation based on the physical dynamics is disregarded but the force/torque is computed by a simple method such as interpolation (S205) to thereby operate the haptic device 10 (S206).

While the haptic simulation is progressed, the above steps are repeatedly performed to thereby provide a user with the real-time haptic interaction (S207).

As described previously, according to a haptic simulation system and method for providing real-time haptic interaction in the haptic simulation system, a groping function complementing the visual sense or existing in an independent sense under a virtual environment is provided unlike the conventional user interaction method depending on the visual sense, so that more precise navigation chance can be provided in the virtual environment. Also, since the system and method can be widely used in applications requesting more precise interaction that is not provided by the visual sense in the virtual environment, they can be applied usefully to applications such as a virtual surgical operation simulation requesting a fine handling technique using haptic interaction or a virtual manufacturing simulation requesting a complicated assembly of parts.

In addition, since the inventive system and method provide a new type of immersion feeling through a sense of a part of the human body beyond a dimension that the immersion feeling of the user depends only on the conventional visual and hearing special effects, they provide the haptic interaction function to disabled persons such as blind on simulation applications and thus can be used as applications such as computer games for blinds.

The above description is only one embodiment to embody a haptic simulation system and method for providing real-time haptic interaction in the haptic simulation system. It will be apparent to those skilled in the art that various modifications and variations can be made in the present invention. Thus, it is intended that the present invention covers the modifications and variations of this invention provided they come within the scope of the appended claims and their equivalents.

1. A haptic simulation system comprising:
a haptic device for providing a user with a realistic haptic interaction;
a graphic display module for outputting and displaying an avatar depending on a motion of the user and a virtual environment while performing a simulation;
a collision-perceiving module for perceiving a real-time collision information between the avatar and a virtual object in a simulation environment;
a physical dynamics-based force/torque-computing module supplied with the collision information to compute force/torque on the basis of physical dynamics and transfer the computed force/torque to the haptic device; and
a dispersion-computing module being in charge of dispersion computing and synchronization among the graphic display module, the collision-perceiving module and the physical dynamics-based force/torque-computing module during a haptic circulation cycle.

2. The haptic simulation system of claim 1, further comprising:
a timer for checking a processing time of the physical dynamics-based force/torque-computing module after the collision information is transferred; and
an interpolation-based force/torque-computing module called instead of the physical dynamics-based force/torque-computing module when the physical dynamics-based processing time exceeds a prescribed time, for computing force/torque on the collision information on the basis of an interpolation method and transferring the computed information to the haptic device.

3. The haptic simulation system of claim 1, wherein the graphic display module and the physical dynamics-based force/torque-computing module are respectively executed in separate CPUs on a network or in different threads on a CPU.

4. A method for providing a real-time haptic interaction in a haptic simulation system, the method comprises the steps of:
(a) operating an avatar within a virtual environment depending on a motion of the user in a haptic device while performing a haptic simulation;
(b) perceiving a collision information of when the avatar of the user collides with an object of the virtual environment;
(c) computing force/torque on the collision information on the basis of physical dynamics;
(d) when the processing time of the step (c) exceeds a prescribed time, computing force/torque on the collision information using an interpolation method instead of the physical dynamics-based processing; and
(e) transferring the force/torque values computed in the steps (c) and (d) to the user haptic device to provide the user with the haptic interaction.

5. The method of claim 4, wherein a first processing unit for performing the steps (a), (b) and (d) and a second processing unit for performing the step (c) are executed in separate CPUs on a network or in different threads on a CPU.

6. The method of claim 5, further comprising the step of processing dispersion computing and synchronization between the first processing unit and the second processing unit during a haptic circulation cycle.
